(19) United States
(12) Patent Application Publication
(10) Pub. No.: US 2014/0229489 A1
(43) Pub. Date: Aug. 14, 2014

(54) Data Storage System

(71) Applicants: Richard Low, London (GB); Andrew Suffield, London (GB)

(72) Inventors: Richard Low, London (GB); Andrew Suffield, London (GB)

(73) Assignee: Acunu Limited, London (GB)

(21) Appl. No.: 14/118,432

(22) PCT Filed: May 24, 2012
(86) PCT No.: PCT/GB2012/051176

§ 371 Date: Mar. 26, 2014

(30) Foreign Application Priority Data
May 24, 2011 (GB) 1108640.2

(51) Int. Cl. G06F 17/30

(52) U.S. Cl. CPC G06F 17/30321
USPC 707/741

(57) ABSTRACT

A system (1) comprises a plurality of data structures. Each of the data structures comprises an association to a disjoint key range Ri=[k_i,k_{i+1}), where k_i is an ordered sequence arranged to be held in an internal memory (3) key range index. The system is arranged to allow membership queries for a key within the system to be performed by searching the key range index for the unique range Ri containing the key, and then querying the data structure associated with the range Ri for membership of the key.

This invention relates to methods, systems and media for data storage. In particular, this invention relates to methods, systems and media for data storage using external memory Bloom filters.

A Bloom filter is a probabilistic data structure that is used to test whether an element is a member of a set. More specifically, a Bloom filter is a compact data structure designed to perform membership queries, i.e. does a specified set of objects contain this object: “contains(x)”, with zero false negative rate and small false positive rate. So the query “contains(x)” should always return true when x is in fact in the set, but might return true even when x is not in the set. A Bloom filter can give good false positive rate with O(1) bits per item stored in the set.

External memory Bloom filters (EMBFs) are designed to operate outside of in-core storage, for example operating on disks or solid-state devices. In particular, “blocked”, “bucketed” or “partitioned” Bloom filters have been suggested by Putze et al in “Cache-, Hash- and Space-Efficient Bloom Filters”, Journal of Experimental Algorithmics, Volume 14, December 2009; by Kirsch et al in “Less hashing, same performance: building a better Bloom filter”, ESA '06 Proceedings of the 14th conference on Annual European Symposium—Volume 14, pp. 456-467, 2006; and by Manber et al in “An algortihm for approximate membership checking with application to password security”, Information Processing Letters, Volume 50, Issue 4, pp. 191-197, 25 May 1994.

U.S. 7,743,013 entitled “Data partitioning via bucketing Bloom filters” discloses a system in which there are two or more sets of disjoint elements and it is wished to know quickly which set a given element is in. These traditional EMBFs use a blocking or buckteing strategy in which a set of smaller Bloom filters F_{—}0, F_{—}1, . . . , F_r are constructed, which are typically each of size equal to the desired disk block size. Each key k is first hashed to the range [0,r] using some hash function h, then the filter F_{h(k)} is loaded into memory and the desired operation (query or update) performed on that filter, and then, if modified, it is written back to disk. Alternatively, the bits of filter F_{h(k)} can be modified directly on disk or otherwise, without loading the entire filter into memory (but the idea is to size the filters F_i so that they can efficiently be loaded into memory rather than operating on individual bits).

However, building these EMBFs either requires the entire EMBF to be stored in memory or requires a substantial amount of random IO per update operation, since each key typically involves a different filter F_i to be loaded and re-written. When the Bloom filter is too big to fit in memory, its performance is very bad both for queries and updates: each such operation requires multiple random accesses to the filter, so if it is on disk then that results in multiple seeks per insert, which is very slow.

The present invention aims to provide an improved data storage system.

When viewed from a first aspect the invention provides a system for staging on a data processing apparatus, the system comprising a plurality of data structures, each of said data structures comprising an association to a disjoint key range Ri=[k_i,k_{i+1}), wherein k_i is an ordered sequence arranged to be held in an internal memory key range index, and wherein the system is arranged to allow membership queries for a key within the system to be performed by searching the key range index for the unique range Ri containing the key, and then querying the data structure associated with the range Ri for membership of the key.

A membership query is a query which enquires whether a particular key is stored within the system.

When viewed from a second aspect the invention provides a method of performing a membership query for a key within a system containing data, wherein the system comprises a plurality of data structures, each of said data structures comprising an association to a disjoint key range Ri=[k_i,k_{i+1}), wherein k_i is an ordered sequence arranged to be held in an internal memory key range index, the method comprising:
searching the key range index for the unique range Ri containing the key, and
querying the data structure associated with the range Ri for membership of the key.

The invention also extends to a computer readable data storage medium for storing one or more data records, e.g. keys, in the system as set out in the first aspect.

Thus it will be appreciated that the as the keys are in an ordered sequence, these are seen in order by the membership query which, in one set of embodiments, means that only a single data structure needs to be held in memory at a time, which therefore allows the system to use very little random input-output (IO), i.e. the majority of the IO is sequential.

The plurality of data structures could comprise any suitable type of data structures, but in one set of embodiments the plurality of data structures each comprises a Bloom filter. In the context of the key-value dictionary of the present invention, a Bloom filter for the dictionary needs only store a few bits per key rather than the whole key and its associated value(s). Therefore Bloom filters are usually small enough to store in memory, and avoid having to perform IO-expensive queries if an item is not in the store.

Preferably the Bloom filters are external memory Bloom filters (EMBFs). In one set of embodiments, the keys to be inserted are presented in sequential order, e.g. when the EMBF has bounded memory. This is particularly useful, for example, in the merging of two sorted array of keys, where the output of the merge is constructed in sequential order, and hence an associated EMBF can be efficiently constructed to an output array.

In one set of embodiments each data structure, e.g. an EMBF which includes E_{—}0, E_{—}1, . . . , E_q, comprises a fixed number of distinct keys in the range [k_i,k_{i+1}). This is generally referred to as a “chunked” EMBF (CEMBF), in which the “chunk” keys {k_i] can be computed efficiently during the construction so that each EMBF, E_i, contains the desired number of distinct keys. In addition, an auxiliary index structure may be maintained on the boundary keys k_{—}0, k_{—}1, . . . , k_{r+1}. This key range index could comprise any indexing structure, such as an in-memory array, a binary tree, a B-tree or other searchable data structure, which could depend on the number of boundary keys.

Generally, the data structures, e.g. the Bloom filters or which ever type these are, each have a fixed amount of memory. Preferably this memory size is independent of the total dataset size. In one set of embodiments the data structures, e.g. Bloom filters, are constructed during the merge of two or more key arrays. For example in the set of embodiments comprising EMBFs, preferably each the EMBFs has a bounded memory and the EMBFs are constructed during a merge of a set of associated key arrays. Preferably the keys to be inserted into each EMBF are presented in sequential order.

The CEMBF will generally include a number of parameters to define its attributes, e.g. its size. In one particular embodiment the following parameters are used:
α=8, the number of bits per key,
M=1 MB, the size of each individual EMBF,
B=4 kB, the size of each individual Bloom filter within the EMBF,
k=ceil(α ln 2), the number of hash functions to use for the Bloom filter, which is the optimal number, that gives false positive rate ε=2^{-αln}2, and
l=512, the maximum length of a key.

These parameters are useful in a set of embodiments in which the CEMBF is stored on a solid state drive (SSD). Each lookup is one random I/O, so storing on an SSD rather than on a hard disk drive (HDD) will give much faster lookup times. However, the CEMBF is still useful on a HDD. In a set of embodiments in which the CEMBF is stored on a HDD, preferably B=256 KB, corresponding to the larger block size.

The invention also extends to a method for constructing a system as set out in the first aspect from a sequence of sorted keys, comprising assembling each of the plurality of data structures from a contiguous set of keys, flushing the set of keys from memory when full, then inserting a key range Ri=[k_i,k_{i+1}) into the key range index, wherein k_i is the smallest key added into the data structure, and k_{i+1} is the smallest key greater than k_i not included in the data structure.

Thus, during a merge of arrays, a new key array, A, is constructed and its keys are written out in order. This allows the construction of the EMBF, E_i, to be finished before the construction of E_{i+1} is started. By choosing the size of the EMBF to be small enough to be constructed easily in memory, the whole CEMBF can be constructed in a streaming manner. The advantage of this over known EMBF techniques is that the method of the present invention requires a small fixed amount of memory to construct and no random IO. Preferably keys forming an array A are presented to the CEMBF in a sequential order.

In one set of embodiments the CEMBF is built when merging two arrays together during a usual merge process for the doubling array. Suppose the arrays are A₁ and A₂, containing n₁ and n₂ keys respectively. The number of merged keys will be at most n=n₁+n₂. It can be less because the two arrays may contain the same keys (in which case one takes preference as it was written later).

Generally, each EMBF can store n_{c}=8M/αkeys. Therefore the number of chunks is q=ceil(n/(8M/α)) (where ceil(x) is the smallest integer no smaller than x). The space required for the chunk keys is lq. Therefore in one set of embodiments q(M+l) space is preallocated on the storage device (if required) to store the entire CEMBF. This could be an overestimate because the keys could be shorter than l or there may be fewer than n unique keys. In the case that whole chunks are not needed, there are no keys added to the chunk key list and the extra chunks are not used.

Once the system has been constructed, there are a number of functions which can be used on the system. A typical EMBF implementation has two methods, embf_insert(h, k, location) and embf_lookup(h, k, location). The inputs to both these functions are the hash function h, key k and the location (either a buffer in memory or on disk) of the start of the EMBF. The function embf_insert will insert the key into the EMBF; embf_lookup performs an EMBF lookup returning false if the key is not present and true if the key may be present.

For a query, the chunk key list will be very small, e.g. with the parameters set out above it will be 512 kB for 1 billion keys. Therefore it can be assumed that it is always stored in the memory, i.e. it is stored on disk just for persistence. For a lookup query the algorithm is:

```
lookup_cembf(k):
  let chunk_num = binary_search(k, chunk_keys)
  return embf_lookup(h, k, chunk_num)
```

The function embf_lookup uses the variable chunk_num as an offset to find the correct EMBF for the key.

The EMBF can use any suitable hash function. In one set of embodiments the EMBF uses the Murmur has, since this is very fast to compute. Instead of computing k times, the hash is only computed twice. Let h(k,s) be the hash function on key k with seed s. Let h₁=h(k,0) and h₂=h(k,h1). Then the bit positions bᵢ derived from the hash function are given by bᵢ=h₁+i h₂ mod 8B.

The hash function can also be used to decide which of the individual filters to use in each EMBF. This is given by h(k,l) mod M/B. The seed of 1 is used so there is little correlation between this hash function and the one described above to find the bit positions.

The data stored in the system could be located in any suitable memory location. In one set of embodiments the data is in a cache and the Bloom filter is stored elsewhere. For example, if a range query had been performed recently, the keys would already be in cache but the Bloom filter would not. In these embodiments, if a get was then performed, the Bloom filter would be queried before the array, which would be wasted. This could be eliminated by first checking to see if the required part of the array is already in cache. If it is, Bloom filter lookup could be skipped.

In one set of embodiments the construction of the CEMBF can be extended to help with range queries across multidimensional keys. In these embodiments the keys are of the form [d1, d2, . . . , dk−1, dk]. Many queries will result in just one dimension changing, i.e. they will be from [d1, d2, . . . , di, . . . , dk] to [d1, d2, . . . , di′, . . . , dk]. To use the CEMBF to help with such queries, the key [d1, d2, . . . , di−1, di+1, . . . , dk] (i.e. with the ith dimension removed) could be added to the CEMBF. This can be further extended to range queries with more than one dimension changing by removing all of the changing dimensions.

In another set of embodiments, if there is just one array, or the query has got to the last array without finding the key, it may be better to not query the CEMBF. If the key requested is present, then it is guaranteed to be present when querying the last array so consulting the CEMBF is unnecessary. However, if the key is not present then the CEMBF should be queried. Statistics could be used to decide this, e.g. if most keys requested are present then do not query the CEMBF on the last array.

An embodiment of the invention will now be described by way of example with reference to the accompanying drawing.

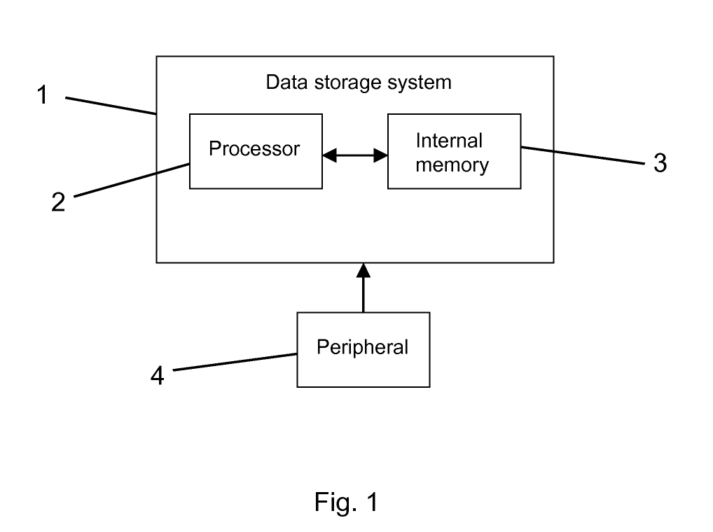

FIG. 1 shows an embodiment of a data processing system on which the present invention could be staged.

FIG. 1 shows a data storage system 1 on which the system of the present invention can be staged. The data storage system 1 includes a processor 2 on which the steps of the method of the present invention can be run, and an internal memory 3 in which the data structures, data records, i.e. keys, and the key range index can be stored. A peripheral 4, e.g. a mouse or keyboard, allows a user to interact with the system, e.g. to specify which of the keys is to form the subject of the membership query.

A system in accordance with the invention, containing a CEMBF is constructed using the algorithm build_cembf(it, n), as described below, during the merge of two arrays A₁ and A₂. it is the merged iterator reading keys from arrays A₁ and A₂. The function flush writes the EMBF buffer out to disk, and similarly, the function flush_key_array writes the chunk key array to disk. h is a has function, the Murmur hash being used here.

```
build_cembf(it, n) :
  let inserted_this_chunk = 0
  let chunk_num = 0
  let chunk_keys = [ ]
  let chunk_buf = malloc(M)
  while it.has_next( ) do
    let k = it.next( )
    embf_insert(h, k, chunk_buf)
    inserted_this_chunk := inserted_this_chunk + 1
    if inserted_this_chunk = n_c then
      chunk keys := chunk_keys :: k
      flush(chunk_num, chunk_buf)
      chunk_num := chunk_num + 1
      inserted_this_chunk := 0
    end for
  end while
  if inserted_this_chunk > 0 then
    chunk_keys := chunk_keys :: k
    flush(chunk_num, chunk_buf)
  flush_key_array(chunk_keys)
```

The CEMBF created has the following parameters to define its attributes:
α=8, the number of bits per key,
M=1 MB, the size of each individual EMBF,
B=4 kB, the size of each individual Bloom filter within the EMBF,
k=ceil(αln 2), the number of hash functions to use for the Bloom filter, which is the optimal number, that gives false positive rate ε=2^{-α}ln2, and
l=512, the maximum length of a key.

The CEMBF created has bounded memory, when the keys to be inserted, i.e. forming an array A, are presented in sequential order. It contains a collection of traditional EMBFs, E_{—}0, E_{—}1, . . . , E_q, with each E_i containing a fixed number of distinct keys in the range [k_i, k_{i+1}). The chunk keys {k_i} can be computed efficiently during the construction of the CEMBF so that each E_i contains the desired number of distinct keys. In addition, an auxiliary index structure on the boundary keys k_{—}0, k_{—}1, . . . , k_{r+1} is maintained.

1. A system for staging on a data processing apparatus, the system comprising a plurality of data structures, each of said data structures comprising an association to a disjoint key range Ri=[k_i,k_{i+1}), wherein k_i is an ordered sequence arranged to be held in an internal memory key range index, and wherein the system is arranged to allow membership queries for a key within the system to be performed by searching the key range index for the unique range Ri containing the key, and then querying the data structure associated with the range Ri for membership of the key.

2. A system as claimed in claim 1, wherein the plurality of data structures each comprises a Bloom filter.

3. A system as claimed in claim 2, wherein the Bloom filter uses a murmur hash.

4. A system as claimed in claim 1, 2 or 3, wherein the plurality of data structures each comprises an external memory Bloom filter.

5. A system as claimed in claim 1, wherein the key range index comprises a b-tree, a binary tree, an in-memory array, or other searchable data structure.

6. A system as claimed in claim 1, wherein the data structures each have a fixed amount of memory.

7. A system as claimed in claim 6, wherein the fixed amount of memory for each data structure is independent of the total dataset size.

8. A system as claimed in claim 1, wherein the data structures are constructed during the merge of two or more key arrays.

9. A system as claimed in claim 1, wherein each data structure comprises a fixed number of distinct keys in the range [k_i,k_{i+1}).

10. A system as claimed in claim 1, wherein an auxiliary index structure is maintained on the boundary keys k_{—}0,k_{—}1, . . . , k_{r+1}.

11. A method for constructing a system as claimed in claim 1 from a sequence of sorted keys, comprising assembling each of the plurality of data structures from a contiguous set of keys, flushing the set of keys from memory when full, then inserting a key range Ri=[k_{—i,k}_{i+1}) into the key range index, wherein k_i is the smallest key added into the data structure, and [k_{i+1} is the smallest key greater than k_i not included in the data structure.

12. A method as claimed in claim 11, wherein the keys to be inserted are presented in sequential order.

13. A computer readable data storage medium for storing one or more data records in a system as claimed in claim 1.

14. A method of performing a membership query for a key within a system containing data, wherein the system comprises a plurality of data structures, each of said data structures comprising an association to a disjoint key range Ri=[k_i,k_{i+1}), wherein k_i is an ordered sequence arranged to be held in an internal memory key range index, the method comprising:
searching the key range index for the unique range Ri containing the key, and
querying the data structure associated with the range Ri for membership of the key.

15. A method as claimed in claim 14, wherein the plurality of data structures each comprises a Bloom filter.

16. A method as claimed in claim 15, wherein the Bloom filter uses a murmur hash.

17. A method as claimed in claim 14, wherein the plurality of data structures each comprises an external memory Bloom filter.

18. A method as claimed in claim 14, wherein the key range index comprises a b-tree, a binary tree, an in-memory array, or other searchable data structure.

19. A method as claimed in claim 14, wherein the data structures each have a fixed amount of memory.

20. A method as claimed in claim 19, wherein the fixed amount of memory for each data structure is independent of the total dataset size.

21. A method as claimed in claim 14, wherein the data structures are constructed during the merge of two or more key arrays.

22. A method as claimed in claim 14, wherein each data structure comprises a fixed number of distinct keys in the range [k_i,k{i+1}).

23. A method as claimed in claim 14, wherein an auxiliary index structure is maintained on the boundary keys k_{—}0,k_{—}1, . . . , k_{r+1}.
